(19) United States
(12) Patent Application Publication
(10) Pub. No.: US 2018/0173073 A1
(43) Pub. Date: Jun. 21, 2018

(54) ELECTROPHORETIC PRIVACY DEVICES

(71) Applicant: HEWLETT-PACKARD DEVELOPMENT COMPANY, L.P., HOUSTON, TX (US)

(72) Inventors: KUAN-TING WU, TAIPEI CITY (TW); WEI KUANG CHU, TAIPEI CITY (TW); KEVIN VOSS, HOUSTON, TX (US)

(21) Appl. No.: 15/563,150

(22) PCT Filed: Jul. 8, 2015
(86) PCT No.: PCT/US2015/039521

§ 371 Date: Sep. 29, 2017

(51) Int. Cl. G02F 1/167; G02B 5/22; G06F 1/16

(52) U.S. Cl. CPC G02F 1/167; G02B 5/22; G02F 2203/01; G02F 2001/1678; G06F 1/1637

(57) ABSTRACT

An electrophoretic privacy device may include an electrophoretic cell coupled between a first electrode and a second electrode. The electrophoretic cell may comprise a plurality of semi-transparent positively-charged particles and a plurality of semi-transparent negatively-charged particles. The particles may be dispersed in a dielectric fluid in the electrophoretic cell. At least one of the first electrode and the second electrode may be transparent.

### BACKGROUND

Electrophoretic displays are non-emissive devices based on the electrophoresis of charged particles suspended in a fluid. Electrophoretic displays may comprise two electrodes placed opposite each other, with one of the electrodes being transparent. A suspension of a fluid and charged pigment particles may be enclosed between the electrodes. When a voltage difference is imposed between the electrodes, the pigment particles may accumulate toward one of the electrodes so that either the particles or the fluid may be seen through the transparent electrode according to the polarity of the voltage difference.

### BRIEF DESCRIPTION OF THE DRAWINGS

The following detailed description references the drawings, wherein:

FIG. 1 is a schematic diagram of an example electrophoretic privacy device:

FIG. 2 is a schematic diagram of an example electrophoretic privacy device having a plurality of electrophoretic cells;

FIG. 3A is a schematic cross-sectional diagram of an example privacy controlled display; and

FIG. 3B is a schematic cross-sectional diagram of an example privacy controlled display with a touch sensor.

### DETAILED DESCRIPTION

With the rapid growth in the use of electronic devices for communication, the need for hardware that effectively and efficiently present information to users has also grown rapidly. Display devices typically output information in visual form. Electronic displays may convert electrical signal input to display visual information.

Electrophoretic displays, sometimes referred to as electronic paper, e-paper, and electronic ink, may be display technologies that mimic the appearance of ordinary ink on paper. Unlike backlit displays that emit light, electrophoretic displays may reflect light like paper. Electrophoretic displays operate by the motion of dispersed ink particles relative to a fluid under the influence of an electric field—the phenomenon called electrophoresis. Electrophoretic displays may provide an energy efficient and nonvolatile visual display solution, meaning that the display output may be maintained even if power is turned off.

In some applications, such as when sensitive information may be displayed on a screen, privacy measures may be desired to prevent unwanted access of the displayed information. This issue applies to many types of displays. Current solutions include privacy screens on computer monitor screens. However, current solutions may not be effective in various applications. For examples, privacy screens may not be adjustable or tunable so that the screen may be removable or the privacy features switched on and off.

Examples disclosed herein provide for electrophoretic privacy devices to provide privacy control on displays. Example electrophoretic privacy devices may include an electrophoretic cell coupled between a first electrode and a second electrode. The electrophoretic cell may contain a plurality of semi-transparent positively-charged particles and a plurality of semi-transparent negatively-charged particles dispersed in a dielectric fluid. When an electric field is applied across the electrophoretic cell, such as one induced by causing a voltage drop across the electrodes, the particles may accumulate towards opposite ends of the cell close to the electrodes. Adjusting the distribution of the particles may allow different levels or ranges of light transmittance depending on the transparency of the particles. In this manner, examples herein may provide for privacy control by providing control of how much light is passed through the electrophoretic privacy device.

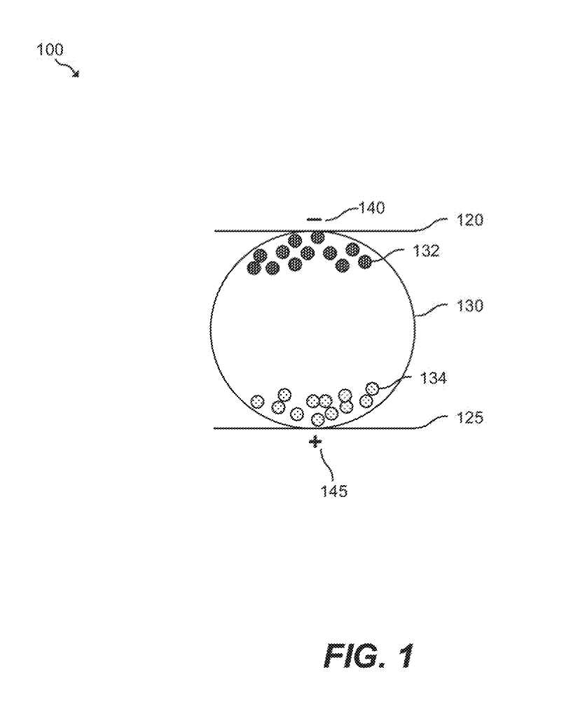

Referring now to the figures, FIG. 1 is a schematic diagram of an example electrophoretic privacy device 100. Electrophoretic privacy device 100 may include an electrophoretic cell 130 coupled between a first electrode 120 and a second electrode 125. Electrophoretic privacy device 100 may provide privacy and security control by allowing the control of how much light is passed through the device.

Electrophoretic cell 30 may include a plurality of semi-transparent positively charged particles 132 and a plurality of semi-transparent negatively-charged panicles 134 dispersed in a dielectric fluid. Electrophoretic cell 130 may include a shell which may be transparent. The shell may contain the dielectric fluid, which may house the plurality of particles. The electrophoretic cell 130 may be round as shown in FIG. 1, or it may be a variety of shapes.

The dielectric fluid may provide electrical insulation, and may prevent corona and arcing. The dielectric fluid may also serve as a coolant. Furthermore, in some examples, the dielectric fluid may be self-healing, which may mean that when an electric breakdown occurs, the discharge channel does not leave a permanent trace in the fluid. The dielectric fluid may include a number of materials, including oils, fluid polymers, and purified water.

The positively-charged particles 132 and the negatively-charged particles may include a colored pigment. In some examples, at least one of the plurality of semi-transparent positively-charged particles 132 and the plurality of semi-transparent negatively-charged particles 134 may include particles with a transmittance of between 10 to 90%. Transmittance may be the effectiveness of a material to transmit radiant energy such as light. For example, transmittance may be the fraction of incident electromagnetic power that is transmitted. Less than full transmittance may depend on the materials used in the particles as well as the concentration of the pigments. The particles may exhibit either transparent or translucent properties or both.

In some examples, the plurality of semi-transparent positively-charged particles 132 may have particles that have a first transmittance, and the plurality of semi-transparent negatively-charged particles 134 may have particles that have a second transmittance. In some examples, all of the plurality of positively-charged particles 132 may have the first transmittance, and all of the plurality of negatively-charged particles 134 may have the second transmittance. In some particular examples, one of the first transmittance and the second transmittance is around 70%, and the other of the first transmittance and the second transmittance is around 30%.

Electrophoretic cell 130 may be coupled between first electrode 120 and second electrode 125. As shown in the example of FIG. 1, electrophoretic cell 130 may be coupled between the electrodes by being physically sandwiched between the two. First electrode 120 and second electrode 125 may be electrically conducting and may cause a voltage drop across electrophoretic cell 130, such as in response to one or both of the electrodes being electrically charged.

In some examples, at least one of the first electrode 120 and the second electrode 125 may be transparent. For example, in some examples, at least one of the first electrode 120 and the second electrode 125 may allow light to pass through the material without being significantly scattered. In some examples, at least one of the first electrode 120 and the second electrode 125 may be translucent In some examples, both of the first electrode 120 and the second electrode 125 may be transparent. Alternatively, one of the electrodes may be transparent.

In some examples, at least one of the first electrode 120 and the second electrode 125 may be positively or negatively charged to control the distribution of the charged particles dispersed in the dielectric fluid within electrophoretic cell 130. As shown in FIG. 1, the first electrode 120 may be of a relatively negative charge 140, while the second electrode 125 may be of a relatively positive charge 145. As a result, positively-charged particles 132 may accumulate near first electrode 120, and negatively-charged particles 134 may accumulate near second electrode 125. In some examples, the particles may retain its distribution within electrophoretic cell 130 even when the electric field is removed, such as when power is turned off.

The charging of the electrodes may be controlled by a control engine. While not pictured in FIG. 1, a control engine may be operably coupled to at least one of the first electrode 120 and the second electrode 125. The control engine may generally represent a combination of hardware and programming. For example, the programming for the control engine may be processor-executable instructions stored on a non-transitory machine-readable storage medium and the hardware for control engine may include a processor. In addition or as an alternative, the control engine may include one or more hardware devices including electronic circuitry for implementing the functionality described.

If, for example, the particles with the higher transmittance is accumulated towards the electrode closest to a viewer, the electrophoretic privacy device 100 may appear lighter than if the particles with the lover tray transmittance is accumulated towards the electrode closest to the viewer. That is, the device may appear lighter if the more transparent particles are closer to the viewer, while the device may appear darker if the less transparent particles are closer to the viewers. Thus, the information presented by the electrophoretic privacy device 100, which may, for example, be used as e-paper, may be lighter or darker depending on the distribution of the semi-transparent particles in the electrophoretic cell 130.

In some examples, one of the first electrode 120 and the second electrode 125 may be charged. In such instances, one of the plurality of semi-transparent positively-charged particles 132 and the plurality of semi-transparent negatively-charged particles 134 may be accumulated towards the charged electrode, depending on the relative polarity of the charge compared to the particles. For example, if the first electrode 120 has negative charge 140 and second electrode 125 is not significant charged, positively-charged particles 132 may accumulate towards first electrode 120, while negatively-charged particles 134 may remain in its original distribution. In some examples, the plurality of semi-transparent positively-charged particles 132 and the plurality of semi-transparent negatively-charged particles 134 may be randomly distributed within electrophoretic cell 130 without influence of an electric field.

In some other examples, electrophoretic privacy device 100 may not display visual information itself but may serve as light filter for controlling the privacy of a separate display to which it is operably coupled. In such examples, the distribution of the particles may dictate the amount of light that may be transmitted through the electrophoretic privacy device 100. For example, electrophoretic privacy device 100 may be coupled on top of a display surface, on an array, underneath a black matrix, or on non-viewing areas of a display.

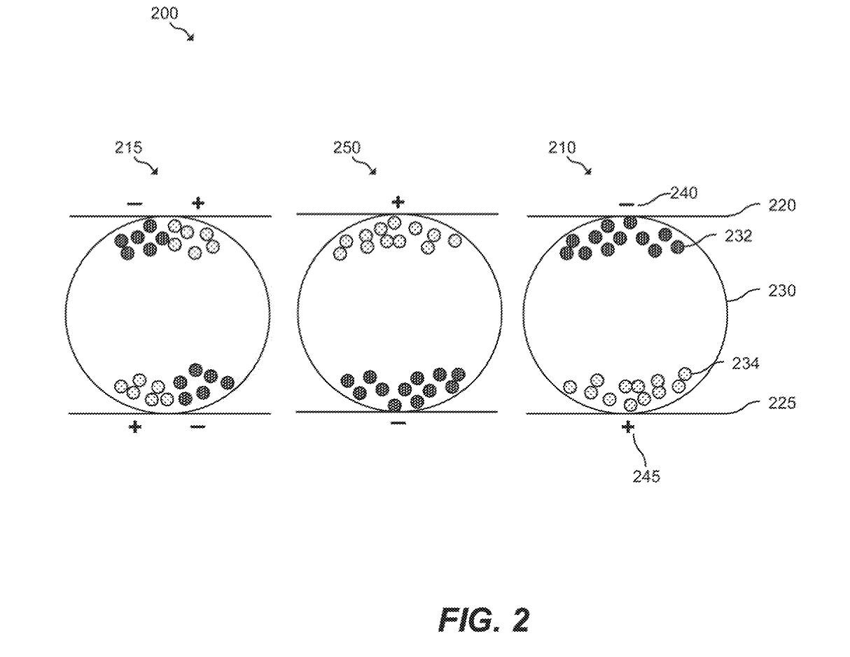

FIG. 2 is a schematic diagram of an example electrophoretic privacy device 200 having a plurality of electrophoretic cells 230 coupled between first electrodes 220 and second electrodes 225. Electrophoretic privacy device 200 may include a number of electrophoretic units, shown as 210, 215 and 250 that are analogous to electrophoretic privacy device 100.

Analogous to electrophoretic cell 130 of FIG. 1, each electrophoretic cell 230 may include a plurality of semi-transparent positively-charged particles 232 and a plurality of semi-transparent negatively-charged particles 234 dispersed in a dielectric fluid. Electrophoretic cell 230 may include a shell which may be transparent. The shell may contain the dielectric fluid, which may house the plurality of particles. The dielectric fluid may provide electrical insulation, and may include a number of materials, including oils, fluid polymers, and purified water.

In some examples, at least one of the plurality of semi-transparent positively-charged particles 232 and the plurality of semi-transparent negatively-charged particles 234 may include particles with a transmittance of between 10 to 90%. In some examples, the plurality of semi-transparent positively-charged particles 232 may have particles that have a first transmittance, and the plurality of semi-transparent negatively-charged particles 234 may have particles that have a second transmittance. In other words, the transmittance of the positively-charged particles 232 may be different than the transmittance of the negatively-charged particles 234, allowing different transmittance levels of the electrophoretic cell depending on particle distribution. In some examples, all of the plurality of positively-charged particles 232 may have the first transmittance, and all of the plurality of negatively-charged particles 234 may have the second transmittance. In some particular examples, one of the first transmittance and the second transmittance is around 70%, and the other of the first transmittance and the second transmittance is around 30%.

Electrophoretic cells 230 may be coupled between first electrodes 220 and second electrodes 225. In some examples, each electrophoretic cell 230 may not be coupled to its own first electrode 220 and second electrode 225. For example, electrophoretic units 210, 215, and 250 may be coupled to one first electrode 220 and to one second electrode 225. Alternatively, electrophoretic units 210, 215, and 250 may be coupled to one first electrode 220 while each unit is coupled to a different second electrode 225. Alternatively, electrophoretic units 210, 215, and 250 may be coupled to one second electrode 225 while each unit is coupled to a different first electrode 220.

In some examples, at least one of the first electrode 220 and the second electrode 225 may be transparent. For example, in some examples, at least one of the first electrode 220 and the second electrode 225 may allow light to pass through t material without being significantly scattered. In some examples, both of the first electrode 220 and the second electrode 225 may be transparent. Alternatively, one of the electrodes may be transparent. For example, the electrode which may be viewable to a user may be transparent while the electrode that is coupled to another device, such as a display, may not be transparent.

In some examples, at least one of the first electrode 220 and the second electrode 225 may be positively or negatively charged to control the distribution of the charged particles dispersed in the dielectric fluid within electrophoretic cell 230. In electrophoretic unit 210, the first electrode 220 may be of a relatively negative charge 240, while the second electrode 225 may be of a relatively positive charge 245. As a result, positively-charged particles 232 may accumulate near first electrode 220, and negatively-charged particles 234 may accumulate near second electrode 225.

In contrast, in electrophoretic unit 250, the first electrode may be of a relatively positive charge, while the second electrode may be of a relatively negative charge. As a result, positively-charged particles of unit 250 may accumulate near its first electrode, and negatively-charged particles may accumulate near the second electrode.

In some examples, a portion of an electrode may have one charge, while another portion of the electrode may have another charge. FIG. 2 illustrates this in electrophoretic unit 215. As shown, a portion of a first electrode and of a respective portion of a second electrode of electrophoretic unit 215 may be charged to a certain voltage while another portion of the electrodes may be charged to another voltage. This may allow higher resolution for each electrophoretic unit.

Furthermore, if particles with the higher transmittance is accumulated towards the electrode closest to a viewer, that electrophoretic unit may appear lighter than if the particles with the lower transmittance is accumulated towards the electrode closest to the viewer. That is, that portion of electrophoretic privacy device may appear lighter if the more transparent particles are closer to the viewer, while the device may appear darker if the less transparent particles are closer to the viewers. Thus, the information presented by the electrophoretic privacy device 200, which may, for example, be used as e-paper, may be lighter or darker depending on the distribution of the semi-transparent particles in each electrophoretic unit.

When an electrophoretic privacy device 200 includes a plurality of electrophoretic units, such as arranged in a matrix, visual information may be displayed where each unit may serve as a pixel or group of pixels. In such a manner, electrophoretic privacy device 200 may operate as electronic paper.

Alternatively, electrophoretic privacy device 200 may not display visual information itself but may serve as light filter for controlling the privacy of a separate display to which it is operably coupled. In such examples, the distribution of the particles may dictate the amount of light that may be transmitted through the electrophoretic privacy device 200. For example, electrophoretic privacy device 200 may be coupled on top of a display surface, on an array, on top of a black matrix, or on non-viewing areas of a display.

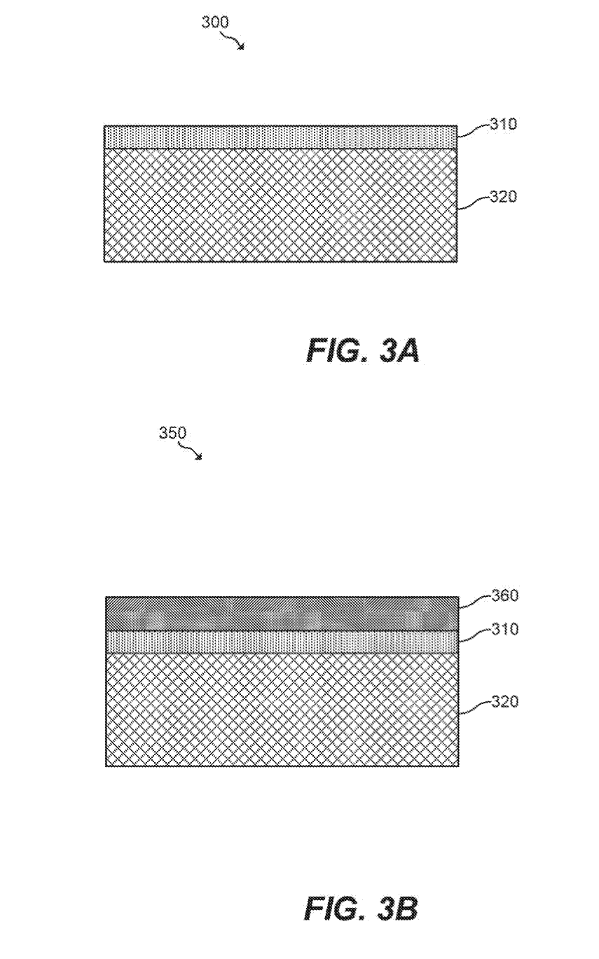

FIG. 3A is a schematic cross-sectional diagram of an example privacy controlled display 300. Privacy controlled display 300 may include an electrophoretic privacy device 310 coupled to a display panel 320.

Privacy controlled display 300 may be a variety of types of electronic visual display depending on the type of display that is display panel 320. Display panel 320 may include any type of electronic visual display. In some examples, display panel 320 may have an active display, such as LCD, organic light-emitting diode (OLED) and polymer light-emitting diode (PLED) displays. Active displays may emit light. In other examples, display panel 320 may have a passive display, such as electrophoretic, electrochromic, electrowetting, Cholesteric LCD and electromechanical displays. Passive displays may present visual information by modulating light.

Active displays may use emitted light to display visual information while passive displays may modulate light from another source to display visual information. Electrophoretic privacy device 310 may control the amount of visibility of the displayed visual information by altering the transmittance of light through the privacy device. As described in FIG. 1 and FIG. 2, electrophoretic privacy device 310 may control how much light passes through, thereby determining the visibility of display panel 320. Accordingly, electrophoretic privacy device 310 may control the brightness clarity, and viewing angle of privacy controlled display 300, among other properties.

FIG. 3B is a schematic cross-sectional diagram of an example privacy controlled display 350 with a touch sensor 360. Privacy controlled display 350 may be similar to privacy controlled display 300 of FIG. 3A and may include display panel 320 coupled to electrophoretic privacy device 310.

Touch sensor 360 may be a tactile sensor such as a touch screen. The inclusion of touch sensor 360 allows privacy controls on touch devices such as mobile computers, mobile phones, and tablets. Touch sensor 360 may be coupled to electrophoretic privacy device 310.

In some other examples, touch sensor 360 may not be a separate component of privacy controlled display 350, but may be a part of another component. For example, touch sensor 360 may be built-in to display panel 320.

All of the features disclosed in this specification (including any accompanying claims, abstract and drawings), and/or all of the elements of any method or process so disclosed, may be combined in any combination, except combinations where at least some of such features and/or elements are mutually exclusive.

In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

As used herein, the singular forms “a,” “an,” and “the” mean “one or more.” The terms “including” and “having” are intended to have the same inclusive meaning as the term “comprising.”

What is claimed is:

1. An electrophoretic privacy device, comprising:
a first electrode and a second electrode, wherein at least one of the first electrode and the second electrode is transparent; and
an electrophoretic cell coupled between the first electrode and the second electrode, wherein the electrophoretic cell comprises a plurality of semi-transparent negatively-charged particles and a plurality of semi-transparent positively-charged particles dispersed in a dielectric solvent.

2. The electrophoretic privacy device of claim 1, comprising a plurality of the first electrodes, a plurality of the second electrodes, and a plurality of the electrophoretic cells, wherein each of the electrophoretic cells is coupled between one of the plurality of first electrodes and one of the plurality of second electrodes.

3. The electrophoretic privacy device of claim 1, wherein at least one of the plurality of semi-transparent negatively-charged particles and the plurality of semi-transparent positively-charged particles comprises particles with a transmittance of between 10 to 90%.

4. The electrophoretic privacy device of claim 1, wherein the plurality of semi-transparent negatively-charged particles comprises particles having a first transmittance and the plurality of semi-transparent positively-charged particles comprises particles having a second transmittance.

5. The electrophoretic privacy device of claim 4, wherein one of the first transmittance and the second transmittance is around 70% and the other of the first transmittance and the second transmittance is around 30%.

6. The electrophoretic privacy device of claim 1, wherein at least one of the first electrode and the second electrode is positively or negatively charged to control the distribution of the plurality of semi-transparent negatively-charged particles and of the plurality of semi-transparent positively-charged particles in the electrophoretic cell.

7. A display privacy controller, comprising:
a first electrode and a second electrode, wherein at least one of the first electrode and the second electrode is transparent;
an electrophoretic cell coupled between the first electrode and the second electrode, wherein the electrophoretic cell comprises a plurality of semi-transparent negatively-charged particles and a plurality of semi-transparent positively-charged particles dispersed in a dielectric solvent; and
a control engine operably coupled to at least one of the first electrode and the second electrode, wherein the control engine is to charge the at least one of the first electrode and the second electrode to control distribution of the plurality of semi-transparent negatively-charged particles and the plurality of semi-transparent positively-charged particles in the electrophoretic cell.

8. The display privacy controller of claim 7, comprising a plurality of the first electrodes, a plurality of the second electrodes, and a plurality of the electrophoretic cells, wherein each of the electrophoretic cells is coupled between one of the plurality of first electrodes and one of the plurality of second electrodes.

9. The display privacy controller of claim 7, wherein at least one of the plurality of semi-transparent negatively-charged particles and the plurality of semi-transparent positively-charged particles comprises particles with a transmittance of between 10 to 90%

10. The display privacy controller of claim 7, wherein the plurality of semi-transparent negatively-charged particles comprises particles having a first transmittance and the plurality of semi-transparent positively-charged particles comprises particles having a second transmittance.

11. The display privacy controller of claim 10, wherein one of the first transmittance and the second transmittance is around 70% and the other of the first transmittance and the second transmittance is around 30%.

12. A privacy controlled display, comprising:
a display panel;
a display privacy controller coupled to the display panel, comprising:
a first electrode and a second electrode, wherein at least one of the first electrode and the second electrode is transparent;
an electrophoretic cell coupled between the first electrode and the second electrode, wherein the electrophoretic cell comprises a plurality of semi-transparent negatively-charged particles having a first transmittance and a plurality of semi-transparent positively-charged particles having a second transmittance dispersed in a dielectric solvent; and
a control engine operably coupled to at least one of the first electrode and the second electrode, wherein the control engine is to charge the at least one of the first electrode and the second electrode to control distribution of the plurality of semi-transparent negatively-charged particles and the plurality of semi-transparent positively-charged particles in the electrophoretic cell.

13. The privacy controlled display of claim 12, further comprising touch sensors.

14. The privacy controlled display of claim 12, wherein at least one of the plurality of semi-transparent negatively-charged particles and the plurality of semi-transparent positively-charged particles comprises particles with a transmittance of between 10 to 90%

15. The privacy controlled display of claim 12, wherein the display privacy controller comprises a plurality of the first electrodes, a plurality of the second electrodes, and a plurality of the electrophoretic cells, wherein each of the electrophoretic cells is coupled between one of the plurality of first electrodes and one of the plurality of second electrodes.
